(19) United States
(12) Patent Application Publication
(10) Pub. No.: US 2025/0083726 A1
(43) Pub. Date: Mar. 13, 2025

(54) DOUBLE-LAYER FOLDING CART

(71) Applicant: Zhejiang Pride Leisure Products Co,. Ltd., Jinhua (CN)

(72) Inventor: Benlong SUN, Jinhua (CN)

(21) Appl. No.: 18/829,261

(22) Filed: Sep. 9, 2024

(30) Foreign Application Priority Data
Sep. 8, 2023 (CN) 202322448451.9

(51) Int. Cl. B62B 3/02; B62B 5/04; B62B 5/06

(52) U.S. Cl. CPC B62B 3/02; B62B 5/065; B62B 5/067; B62B 5/0433

(57) ABSTRACT

A double-layer folding cart having a cart frame and a hand lever riveted to a front end of the cart frame. The cart frame having four support rods and chassis, casters are arranged at bottoms of the four support rods, the chassis include an upper chassis and a lower chassis, and each comprise a center seat and four bottom rods with one ends riveted to four corners of the center seat respectively, the other ends of the bottom rods of the upper chassis are slidably connected with the support rods, and the other ends of the bottom rods of the lower chassis are riveted to lower ends of the support rods. The double-layer folding cart has two layers of storage planes, thus being able to transport more articles every time, and can be folded to be stored, thus occupying a smaller space.

### BACKGROUND OF THE INVENTION

### 1. Technical Field

The invention belongs to the technical field of carts, and particularly relates to a double-layer folding cart.

### 2. Description of Related Art

Carts, as tools for manually transporting articles in daily life, can conveniently transport light articles in a short distance and are widely used for transporting articles in places where motor vehicles cannot be used. Most existing carts are single-layer carts, such as platform carts with casters at the bottom. The single-layer carts have a limited space for storing articles, and cannot be folded, thus occupying a large space when stored. There are also some double-layer carts. For example, Patent Publication No. CN213594353U discloses a double-layer cart for food processing, which adopts a double-layer structure with two chassis and has a larger storage space than single-layer carts; however, because the double-layer cart cannot be folded, it also occupies a large space when stored, and is inconvenient to carry and store.

### BRIEF SUMMARY OF THE INVENTION

In view of the defects in the prior art, the objective of the invention is to provide a double-layer folding cart, which has two layers of storage planes, thus being able to transport more articles every time, and can be folded to be stored, thus occupying a smaller space.

To fulfill the above objective, the invention adopts the following technical solution: a double-layer folding cart comprises a cart frame and a hand lever riveted to a front end of the cart frame, wherein the cart frame comprises four support rods and chassis, casters are arranged at bottoms of the four support rods, the chassis include an upper chassis and a lower chassis, and each comprise a center seat and four bottom rods with one ends riveted to four corners of the center seat respectively, the other ends of the bottom rods of the upper chassis are slidably connected with the support rods, and the other ends of the bottom rods of the lower chassis are riveted to lower ends of the support rods.

Further, the cart frame comprises mounting bases fixed on the support rods, and the other ends of the bottom rods of the upper chassis are riveted to the mounting bases.

Further, the cart frame further comprises gratings and upper fixed seats arranged at tops of the support rods, the gratings are arranged between the adjacent support rods, upper ends on a same side of each grating are riveted to the upper fixed seats on the corresponding support rods, lower ends on a same side of each grating are slidably connected to the corresponding support rods, and each grating comprises at least one riveted cross rod.

Furthermore, the cart frame further comprises sliders arranged above the upper chassis and slidably connected with the support rods, and one ends of the sliders are riveted to the lower ends on the same side of the gratings.

Furthermore, limiting parts are arranged on upper sides of the support rods.

Further, the cart frame comprises lower fixed seats arranged at the lower ends of the support rods, and the other ends of the bottom rods of the lower chassis are riveted to the lower fixed seats.

Furthermore, the hand lever comprises a handle, an upper link, a link base and two lower links which are arranged from top to bottom, the handle is fixed at a top of the upper link, the upper link penetrates through the link base and is able to slide upward and downward, two sides of the link base are riveted to upper ends of the lower links respectively, and lower ends of the lower links are rotatably connected with the corresponding lower fixed seats and are able to rotate forward and backward.

Furthermore, the hand lever further comprises mounting blocks, the lower ends of the lower links are riveted to the mounting blocks, and the mounting blocks are rotatably connected to the corresponding lower fixed seats and are able to rotate forward and backward.

Further, the casters on a side, provided with the hand lever, of the cart frame are casters with brakes.

Further, the double-layer folding cart further comprises a storage bag arranged on the chassis.

By adopting the technical solution, the invention has the following beneficial effects: the double-layer folding cart is of a double-layer structure, thus being able to transport more articles at a short distance every time and reducing the number of times of transportation; the center seats of the chassis can be pulled upward to drive the whole chassis to be folded, each side of the gratings can be folded to reduce the area of each side of the cart frame, the whole cart frame can be folded, and the handle can be folded towards the cart frame, and the whole cart has a smaller size after being folded, thus being more convenient to store and transport; after being unfolded, the cart can be pulled by means of the hand lever to transport articles indoors or can also be carried by vehicles to be used outdoors for camping or other activities; and the double-layer folding cart is simple in structure, and convenient and fast to use.

### BRIEF DESCRIPTION OF THE SEVERAL VIEWS OF THE DRAWINGS

FIG. 1 is a three-dimensional view of a double-layer folding cart, from one perspective;

FIG. 2 is a three-dimensional view of the double-layer folding cart, from another perspective;

FIG. 3 is a side view of the double-layer folding cart;

FIG. 4 is a front view of the double-layer folding cart.

In the figures: 1, support rod; 2, caster; 3, chassis; 3a, upper chassis; 3b, lower chassis; 31, center seat; 32, bottom rod; 4, mounting base; 5, grating; 5a, cross rod; 6, upper fixed seat; 7, slider; 8, upper limiting part; 9, lower fixed seat; 10, hand lever; 101, handle; 102, upper link; 103, link base; 104, lower link.

### DETAILED DESCRIPTION OF THE INVENTION

Specific embodiments of the specific solution of the invention will be further expounded below in conjunction with the accompanying drawings to gain a better understanding of the technical solution of the invention.

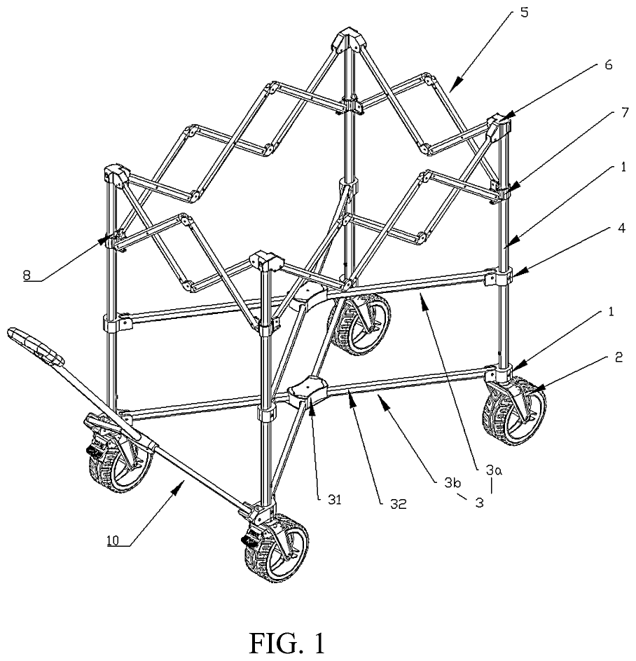

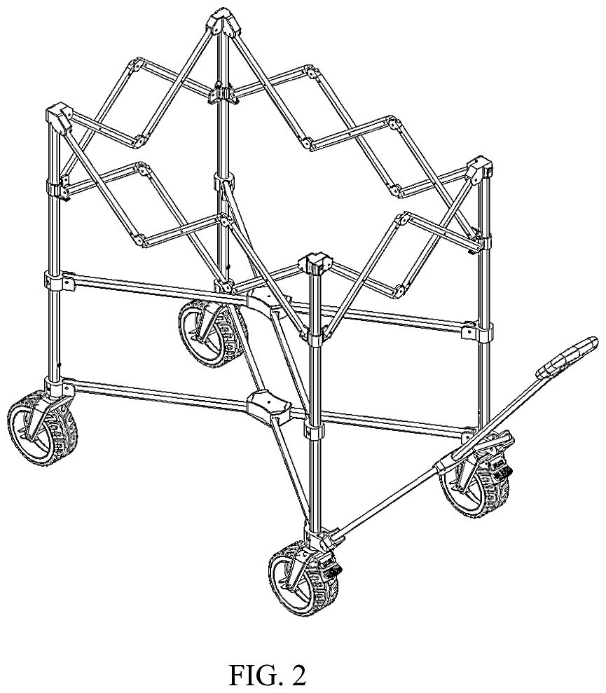

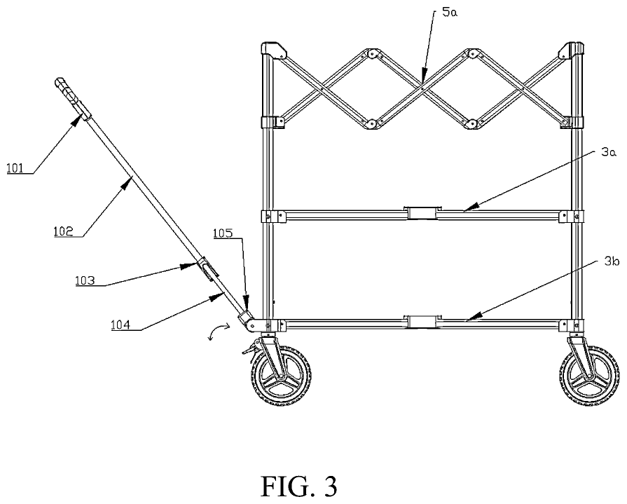

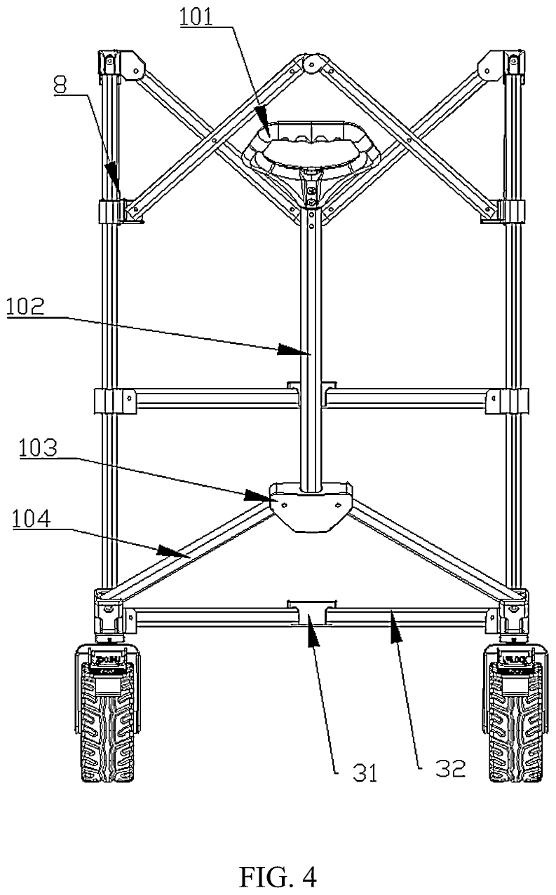

As shown in FIG. 1-FIG. 4, this embodiment provides a double-layer cart, which comprises a cart frame and a hand lever riveted to a front end of the cart frame, wherein the cart frame comprises four support rods 1 and chassis 3, wherein casters 2 are arranged at bottoms of the four support rods 1, the chassis 3 include an upper chassis 3a and a lower chassis 3b, and each comprise a center seat 31 and four bottom rods 32 with ones riveted to four corners of the center seat respectively, the other ends of the bottom rods of the upper chassis 3a are slidably connected with the support rods, and the other ends of the bottom rods of the lower chassis 3b are riveted to lower ends of the support rods. When the cart needs to be folded, the center seat 31 is pulled upward to drive the four bottom rods 32 connected with the center seat 31 to be folded towards the center, and then the support rods 1 connected with the bottom rods 32 are driven to be folded towards the center, such that the cart is folded.

The cart frame comprises mounting bases 4 fixed on the support rods 1, and the other ends of the bottom rods of the upper chassis 3a are riveted to the mounting bases 4.

The cart frame further comprises upper fixed seats 6 arranged at tops of the support rods, a grating 5 is arranged between every two adjacent support rods 1, upper ends on a same side of each grating 5 are riveted to the upper fixed seats on the corresponding support rods, lower ends on a same side of each grating 5 are slidably connected with the corresponding support rods 1, each grating 5 comprises at least one riveted cross rod, each cross rod is formed two tubes riveted together in the middle, and as shown in the figures, the gratings on front and back sides are formed by two articulated cross rods, and the gratings on left and right sides are formed by three riveted cross rods. Because the grating 5 comprises the cross rod formed by two riveted tubes, the four sides, corresponding to the gratings 5, defined by the four support rods 1 can be folded.

The cart frame further comprises sliders 7 arranged above the upper chassis 3a and slidably connected with the support rods 1, and one ends of the sliders 7 are riveted to the lower ends on the same side of the gratings 5.

Upper limiting parts 8 are arranged on upper sides of the support rods 1. The upper limiting parts 8 protrude out of surfaces of the support rods 1 and are used for limiting the highest position where the sliders 7 slide.

The cart frame further comprises lower fixed seats 9 arranged at the lower ends of the support rods 1, and the other ends of the bottom rods of the lower chassis 3b are riveted to the lower fixed seats 9.

The hand lever 10 comprises a handle 101, an upper link 102, a link base 103 and two lower links 104 which are arranged from top to bottom, wherein the handle 101 is fixed at the top of the upper link 102, the upper link 102 penetrate s through the link base 103 and is able to slide upward and downward, two sides of the link base 103 are riveted to upper ends of the lower links 104 respectively, and lower ends of the lower links 104 are rotatably connected with the corresponding lower fixed seats 9 and are able to rotate forward and backward. A lower end of the upper link 102 can downward slide to a position below the link base 103 to decrease the length of the whole hand lever 10, and can also rotate to be close to the support rods 1, such that the hand lever is folded.

The handle lever 10 further comprises mounting blocks 105, the lower ends of the lower links 104 are riveted to the mounting blocks 105, and the mounting blocks 105 are rotatably connected with the corresponding lower fixed seats 9 and are able to rotate forward and backward.

The upper fixed seats 6 and the lower fixed seats 9 are mounted on the support rods 1 and are fixed with fasteners such as screws, the support rods 1 penetrate through through-holes in the mounting bases 4, and the mounting bases 4 are fixed on the support rods 1 through fasteners such as screws. In this embodiment, every two riveted or articulated components can move relatively.

The casters 2 on a side, provided with the hand lever, of the cart frame are casters with brakes, such that the cart can be braked quickly during the transportation process if necessary. The casters with brakes may be the tire brake system disclosed by Patent Publication No. CN217575319U, or casters with brakes directly purchased from the market.

In this embodiment, one or two storage bags located on the chassis may be placed in the cart frame to store small articles. Preferably, the storage bag is rectangular and has an open top surface; the storage bag is directly placed on the chassis 3; or, four sides of the storage bag are detachably connected to four sides of the car frame, and specifically the four sides of the storage bag are connected with the gratings or the support rods. The storage bag may be a frame made from cloth, plastic, or metal.

It should be noted that the above embodiments are merely preferred ones of the invention and are used to explain the technical principle of the invention. Those skilled in the art should understand that the invention is not limited to these specific embodiments described here, and those skilled in the art can make various changes, readjustments and substitutions without departing from the protection scope of the invention. Thus, although the invention has been described in detail with reference to the above embodiments, the invention is not limited to the above embodiments, and may include more other equivalent embodiments without departing from the concept of the invention. The scope of the invention is defined by the appended claims.

What is claimed is:

1. A double-layer folding cart, comprising:
a cart frame and a hand lever riveted to a front end of the cart frame;
wherein the cart frame comprises four support rods and chassis;
a plurality of casters are arranged at bottoms of the four support rods;
the chassis includes an upper chassis and a lower chassis, and each comprise a center seat and four bottom rods with one ends riveted to four corners of the center seat respectively;
wherein the other ends of the bottom rods of the upper chassis are slidably connected with the support rods, and the other ends of the bottom rods of the lower chassis are riveted to lower ends of the support rods.

2. The double-layer folding cart according to claim 1, wherein the cart frame comprises mounting bases fixed on the support rods, and the other ends of the bottom rods of the upper chassis are riveted to the mounting bases.

3. The double-layer folding cart according to claim 1, wherein the cart frame further comprises gratings and upper fixed seats arranged at tops of the support rods, the gratings are arranged between the adjacent support rods, upper ends on a same side of each said grating are riveted to the upper fixed seats on the corresponding support rods, lower ends on a same side of each said grating are slidably connected to the corresponding support rods, and each said grating comprises at least one riveted cross rod.

4. The double-layer folding cart according to claim 3, wherein the cart frame further comprises sliders arranged above the upper chassis and slidably connected with the support rods, and one ends of the sliders are riveted to the lower ends on the same side of the gratings.

5. The double-layer folding cart according to claim 4, wherein limiting parts are arranged on upper sides of the support rods.

6. The double-layer folding cart according to claim 1, wherein the cart frame comprises lower fixed seats arranged at the lower ends of the support rods, and the other ends of the bottom rods of the lower chassis are riveted to the lower fixed seats.

7. The double-layer folding cart according to claim 1, wherein the hand lever comprises a handle, an upper link, a link base and two lower links which are arranged from top to bottom, the handle is fixed at a top of the upper link, the upper link penetrates through the link base and is able to slide upward and downward, two sides of the link base are riveted to upper ends of the lower links respectively, and lower ends of the lower links are rotatably connected with the corresponding lower fixed seats and are able to rotate forward and backward.

8. The double-layer folding cart according to claim 7, wherein the hand lever further comprises mounting blocks, the lower ends of the lower links are riveted to the mounting blocks, and the mounting blocks are rotatably connected to the corresponding lower fixed seats and are able to rotate forward and backward.

9. The double-layer folding cart according to claim 1, wherein the casters on a side, provided with the hand lever, of the cart frame are casters with brakes.

10. The double-layer folding cart according to claim 1, further comprising a storage bag arranged on the chassis.

11. The double-layer folding cart according to claim 2, wherein the cart frame further comprises gratings and upper fixed seats arranged at tops of the support rods, the gratings are arranged between the adjacent support rods, upper ends on a same side of each said grating are riveted to the upper fixed seats on the corresponding support rods, lower ends on a same side of each said grating are slidably connected to the corresponding support rods, and each said grating comprises at least one riveted cross rod.
